(19) United States
(12) Patent Application Publication
(10) Pub. No.: US 2025/0181756 A1
(43) Pub. Date: Jun. 5, 2025

(54) API SECURITY SENSITIVE FIELDS

(71) Applicant: INTUIT INC., Mountain View, CA (US)

(72) Inventors: Kiril LASHVICHER, Tel Aviv (IL); Yossi BARSHISHAT, Tel Aviv (IL); Shirley AVISHOUR, Tel Aviv (IL)

(73) Assignee: INTUIT INC., Mountain View, CA (US)

(21) Appl. No.: 18/525,333

(22) Filed: Nov. 30, 2023

(51) Int. Cl. G06F 21/62; G06F 9/54; G06F 21/60

(52) U.S. Cl. CPC G06F 21/6245; G06F 9/547; G06F 21/604

(57) ABSTRACT

An API security system that implements techniques for learning sensitive information fields from a group of API requests. The API security system implementing security measures for protecting the identified sensitive information fields.

### BACKGROUND

Conventional application programming interfaces (API) s support object level authorization, which is an access control mechanism allowing users to retrieve objects (e.g., account information, personal information, etc.) stored on an endpoint device (e.g., server). Object level authorization generally occurs when an API request to retrieve information includes authorized information (e.g., account number, userID, etc.). This is problematic because a bad actor may intercept the API requests to learn the overall structure of the objects in the intercepted API request and to glean sensitive information from the intercepted API request. Once the sensitive information is determined, the bad actor may then modify the sensitive information and initiate subsequent API requests to gain access to the objects (e.g., account information, personal information, etc.) of other users, which is undesirable.

### SUMMARY

Embodiments disclosed herein solve the aforementioned technical problems and may provide other technical solutions as well. Contrary to conventional techniques, the API security system disclosed herein implements techniques for learning sensitive information fields from a group of API requests, and then implementing security measures for protecting the identified sensitive information fields and the information contained therein.

An example embodiment includes a method performed by a processor. The method comprises collecting a subset of application programming interface (API) transactions between a plurality of users and a host system, analyzing fields in the subset of API transactions, the analyzing including identifying the fields as sensitive fields when information in the fields is common to less than or equal to a first predetermined number of the plurality of users, and performing corrective measures to protect the usage of the sensitive fields.

Another example embodiment includes a system. The system may comprise a non-transitory storage medium storing computer program instructions, and one or more processors configured to execute the computer program instructions to cause operations. The operations may comprise collecting a subset of application programming interface (API) transactions between a plurality of users and a host system, analyzing fields in the subset of API transactions, the analyzing including identifying the fields as sensitive fields when information in the fields is common to less than or equal to a first predetermined number of the plurality of users, and performing corrective measures to protect usage of the sensitive fields.

### BRIEF DESCRIPTION OF THE DRAWINGS

FIG. 1 shows a diagram of an example API request and an example resultant API response.

FIG. 2 shows a flowchart of an example process for a bad actor intercepting and modifying information in API requests.

FIG. 3 shows a diagram of an example API request made by a bad actor and an example resultant API response.

FIG. 4 shows a flowchart for the learning phase of the API security system, based on the principles disclosed herein.

FIG. 5 shows a flowchart for the implementation phase of an API security system, based on the principles disclosed herein.

FIG. 6 shows a network diagram of the API security system, based on the principles disclosed herein.

FIG. 7 shows a block diagram of an example computing system that implements various features and processes of the API security system, based on the principles disclosed herein.

### DETAILED DESCRIPTION OF SEVERAL EMBODIMENTS

To mitigate the above deficiencies, embodiments disclosed herein leverage an API security system that learns sensitive fields in API communications (e.g., API requests) that facilitate object level Authorization between a user computer and an end point device (e.g., server). The API security system analyzes a group of API requests to determine how unique or common each field value is with respect to multiple users. The uniqueness of a field value may be an indicator that it is a sensitive field (i.e., a field that has values unique to each user or a small group of users). For example, if a value is common to more than a pre-defined number (N) of users, then the field may be categorized as a non-sensitive field (e.g., public information such as bank address, state of residence, etc.) that does not require protection. In other words, if a bad actor intercepts the API communication, the information in these non-sensitive fields would not be helpful to the bad actor. However, if a value is unique to a single user or common to a small group (e.g., N or less users), the field may be categorized as a sensitive field (e.g., userID, account number, etc.) that may require further protection. In other words, if a bad actor intercepts the API communication, the information in these sensitive fields can be used for malicious purposes.

In one example, a host of a financial system (i.e., server storing financial information of users) may be servicing a number of authorized users. Each authorized user may login to his/her account and then begin utilization of a software application to retrieve personal and/or financial information from the host server. The application generally makes API requests from the user computer to the host server to retrieve desired information. The API security system disclosed herein monitors a number of API requests of a number of users over time. The API security system analyzes the information (i.e., values) in each field of the monitored requests to determine common or unique information between the requests. Common information in a particular field over a large number of users may be an indication to flag the field as a non-sensitive field that does not require intervention. However, unique information in a particular field (e.g., unique to one or just a few users) may be an indication to flag the field as a sensitive field that may benefit from additional security measures. Uniqueness may be measured per user to ensure that a user has one or just a few values for a given field. For example, a social security number (SSN) field may be considered a unique field on a per user basis because each user has one or just a few values (other residencies) for such a field. Therefore, the SSN field may be flagged as a sensitive field. This is in contrast to some fields that may be unique per user (e.g., receipt numbers) but where the user may have many unique numbers for that given field and therefore should not be considered a sensitive field. According to the disclosed principles, these additional security measures may include, but are not limited to, changing the format of the information in the sensitive fields, and/or requiring additional authorization actions by the requesting user device (e.g., re-enter password, etc.).

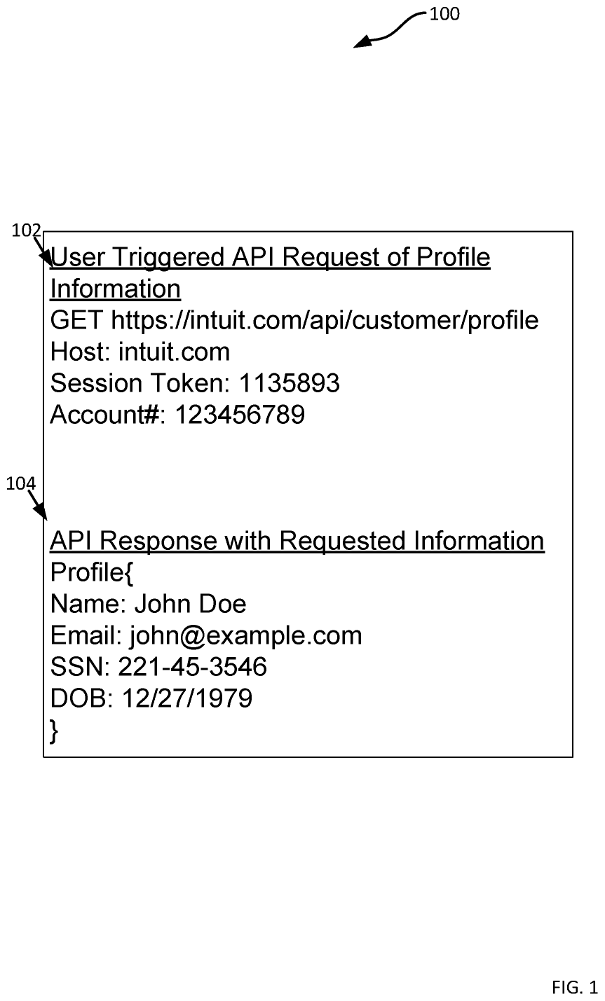

The above-described features are now described in detail with respect to FIGS. 1-7. It is noted that the examples disclosed herein are directed to an API for a financial system. However, it is noted and should be appreciated that the disclosed system and method are applicable to any API.

APIs are generally protocols for facilitating communication between software. The protocols utilized by APIs may include specific formats for sending requests from one software application to another. These requests may be for retrieving desired information which may be personal information or account information from a host software platform. APIs come in various types that may support communication via various protocols, including hypertext transfer protocol (HTTP), which may include commands for requesting information, updating information, and responding with information (e.g., GET, POST, PUT, DELETE, etc.). In these examples, the information (i.e., values) may be structured in a particular format such as Java Script Object Notation (JSON), extensible markup language, XML, etc.

An API request for executing a task such as retrieving information may include information concerning a uniform resource locator (URL) of the host system storing the information, an HTTP command (e.g., GET, etc.) indicating an action to be taken, metadata and other supporting data.

FIG. 1 shows a diagram 100 of an example API request from a user computer and an example resultant API response from a host server. Prior to sending the API request shown in FIG. 1, the user may perform authentication via the host server through methods including entering a userID, password, etc. Once authenticated, the user is able to send API request 102, which may be triggered by a user requesting profile information. The information in API request 102 may include an HTTP GET command that identifies the host server URL, the host identity, a session token generated during user authentication, account information and a HTTP GET command requesting sensitive user profile information. It is noted that in another example, authentication may not be required by the API. In such an example, the user can simply send the API request 102 to the host server.

Once the endpoint device (e.g., host server) receives the API request, the information in the API request (e.g., session token, account number and HTTP command) are unpacked (e.g., a JSON token is analyzed) to access the user account and retrieve the desired user profile information. The user profile information (possibly in JSON format) is transmitted from the host device back to the user device via an API response 104. As shown in FIG. 1, the API response 104 from the host server may include the requested user profile information including the user's full name, email address, social security number and date of birth (DOB).

The API request and response shown in FIG. 1 include valuable information that may be used by a bad actor for malicious purposes. Specifically, the information in the API response 104 includes personal information of the user John Doe, which may be used to access John Doe's account, open unauthorized accounts in the name of John Doe, etc. Interception of this sensitive communication by the bad actor may be facilitated through various systems/processes including, but not limited to, proxy servers acting as an intermediary between the user device and host device and packet sniffing to name a few. Regardless of the technique used, the end result is that the bad actor is able to intercept the API communication and use objects (e.g., values) in the API communication to his/her advantage.

Object level authorization having weak points in API requests and/or API responses make the situation even worse, allowing the bad actor to intercept one or more API communications, determine patterns in the values of the data fields and using these patterns to predict information that can be used to compromise other user accounts. For example, if all API requests for a particular system utilize user account numbers that merely increment between users (e.g., #0001, #0002, etc.), the bad actor can simply increment the value in the account number field to repeatedly retrieve personal profile information of numerous host system users.

These fields are herein referred to as “sensitive fields” because they are unique to less than a predetermined number (N) of users, where N is a low threshold number, and where each of the N users holds one or a few values for each of the given sensitive fields. In one example, N=1 because the sensitive field has a value that is unique to each user (e.g., account number unique to each user). In another example, N may be great than 1 and equal to a limited number of user's that may share some common information (e.g., multiple family members sharing the same account).

Conversely, fields that have data common to a large number of users, or if users own many distinct values of those fields, are herein referred to as “non-sensitive fields”. For example, the URL field in an API request may be considered a non-sensitive field because it is public knowledge and is not valuable to a bad actor. The threshold number may be data common to the predetermined number (N) or more users. The value of N may be set based on various factors including, but not limited to, the number of users on the system, etc.

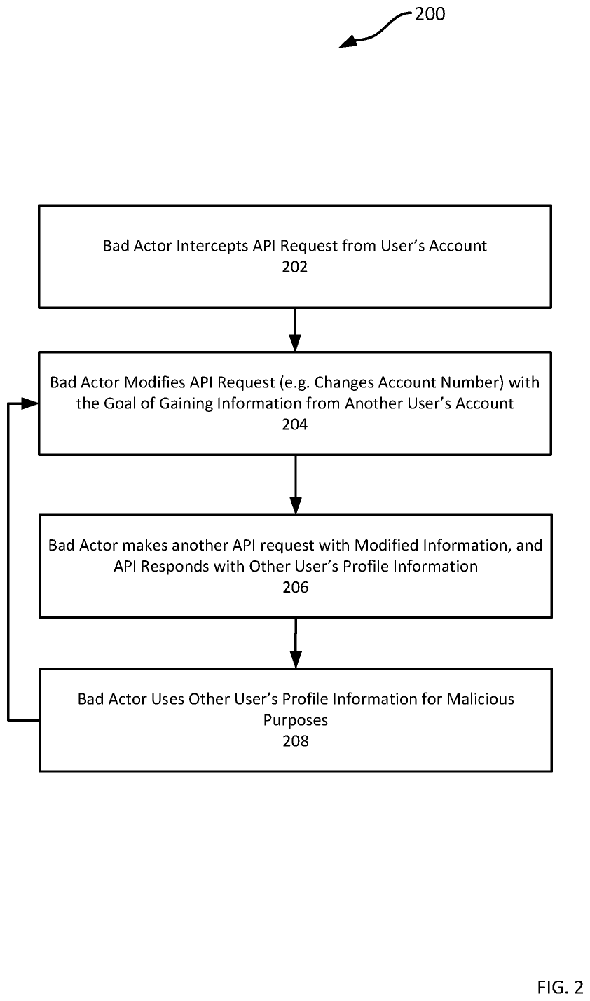

As mentioned above, API communications may be intercepted and utilized by a bad actor for malicious purposes. FIG. 2 shows a flowchart of an example process 200 of a bad actor intercepting and utilizing information in API requests. Specifically, in step 202 the bad actor intercepts the API communication (e.g., API request) made from the user's computer. As mentioned above, interception may be performed by way of a proxy server, packet sniffing or the like. Once the bad actor intercepts one or more API requests, the bad actor in step 204 then identifies one or more sensitive fields in the API request. Identification of the sensitive fields may be achieved by identifying categories of the fields (e.g., account number) and patterns in the field values. Once the sensitive field is identified, the bad actor modifies the information in the sensitive field in step 206. The modification may be an estimation of sensitive information of another user's account. For example, if the bad actor determines that the user account numbers have a pattern, the pattern can be used to select other user's accounts simply by changing (e.g., incrementing) the user account number in the appropriate sensitive field. If the modified information corresponds to another user account, the API unknowingly responds with sensitive information of another user's profile in the appropriate sensitive field in step 206. Once received, the bad actor can use the other user's profile information in step 208 for malicious purposes. This process 200 may be repeated by the bad actor as many times as possible or until the host system realizes the bad actor's actions and takes appropriate countermeasures (e.g., freezes accounts, etc.). It is evident that the bad actor may gain information from numerous accounts before any malicious action is detected (e.g., before the end user realizes their information has been stolen and notifies the host).

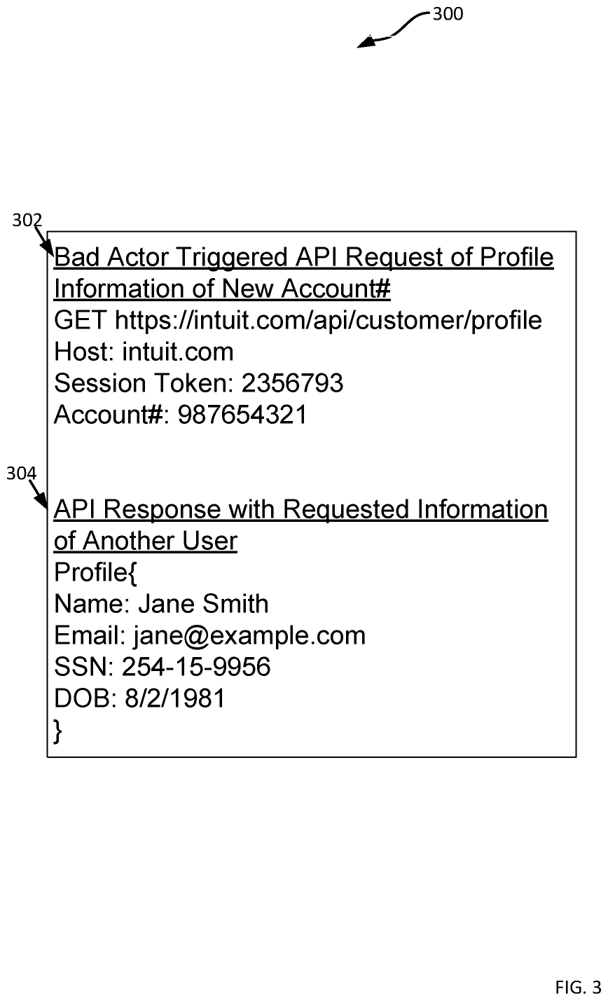

As illustrated in FIG. 2, a bad actor may intercept an API request and send a modified API request to the server with the goal of obtaining sensitive information of other user accounts. FIG. 3 shows a diagram 300 of an example API request 302 made by a bad actor and an example of a resultant API response 304. For example, assume a scenario where the bad actor intercepts the API request 102 shown in FIG. 1. The bad actor may determine that the user account field is a sensitive field and that the account number is merely a sequential number that can be incremented to access other user accounts. In this example, the bad actor modifies API request 102 as API request 302, which includes a similar GET command to the same URL, the same host ID, a session token and a GET command. However, this modified API request 302 includes an incremented user account number (i.e., a number determined by incrementing the intercepted user account number in FIG. 1). Since in this example user account numbers in this host system are merely incremented versions of one another, the incremented user account number will likely correspond to another user's account. When modified, API request 302 is sent to the host, the host unknowingly responds with API response 304, which includes the profile information (e.g., name, email, social security number, date of birth, etc.) of another user Jane Smith that corresponds to the incremented user account number. This process may be repeated by the bad actor.

It is noted that the bad actor can attack the API in other manners that do not require interception of API messages. For example, a bad actor may simply generate an API request attempting to utilize another user's credentials (e.g., user ID). If the bad actor knows another user's ID or correctly guesses another user's ID, the bad actor may generate an API request with the user's ID in an attempt to gain access to the user's account. If the user's ID is legitimate, the host API may unknowingly respond with sensitive information of another user's profile in the appropriate sensitive field. Once received, the bad actor can use the other user's profile information for malicious purposes. This process may be repeated by the bad actor as many times as possible or until the host system realizes the bad actor's actions and takes appropriate countermeasures (e.g., freezes accounts, etc.). It is evident that the bad actor may gain information from numerous accounts before any malicious action is detected (e.g., before the end user realizes their information has been stolen and notifies the host).

The example of the incremental user account number shown in FIGS. 1-3 is an example of what is referred to herein as “broken object level authorization” (BOLA). In other words, the object level authorization (e.g., authorization of a JSON object) performed by sending the user account number from the user computer to the host to access the user profile information is broken because the user account number suffers from a weakness (e.g., a format that can be used to determine other user account numbers). In order to prevent BOLA attacks as described above, the system disclosed herein identifies the “broken” fields in the API communication and either fixes the information in the broken fields or introduces new security measures when making API requests. The solution can include two phases. A first phase, which is a learning phase where the system learns and identifies broken fields in the API communications. A second phase, which is an implementation phase where the system implements measures for fixing or protecting the broken fields in future API communications.

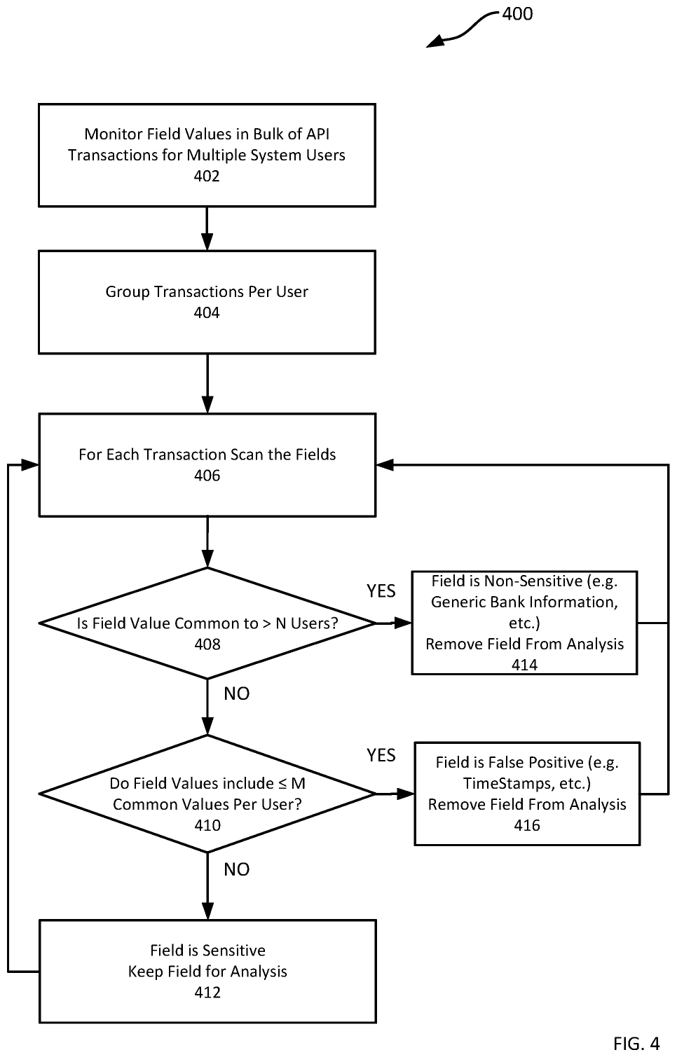

FIG. 4 shows a flowchart of a process 400 for the learning phase of the API security system. The learning phase generally includes the steps of monitoring API transactions between numerous user devices and the host device, identifying sensitive and non-sensitive fields in the API transactions based on a level of uniqueness or commonality in values within the fields, eliminating non-sensitive fields from the analysis and maintaining sensitive fields for further analysis.

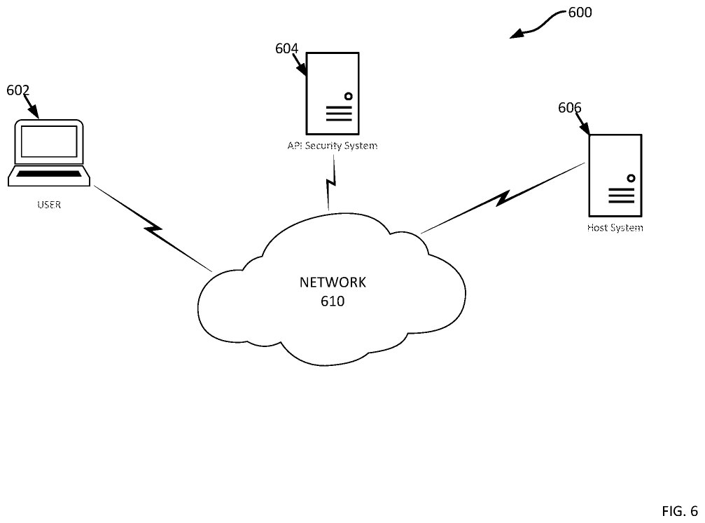

In step 402, API security system 604 (FIG. 6) monitors one or more fields in a bulk (i.e., subset) of monitored API transactions collected for multiple system users on, for example, host system 606. For example, API security system 604 may monitor the command fields, host field, session token field and account number field in the API request 102 and API response 104 shown in FIG. 1. These fields may be monitored for a predefined set number of API transactions for a predefined set number of users. The number of API transactions and number of users may be set based on statistical analysis for a given host software platform to identify broken fields to a level of statistical certainty. In other words, a certain threshold may be set for determining if a field is to be identified as broken or not.

In step 404, API security system 604 may group the monitored transactions per user to ensure that API transactions for a given user are treated in common. For example, API security system 604 may monitor a number (M) of API transactions for a number (N) of users, and then group the API transactions per user such that each user has an associated group of M API transactions. Grouping API transactions per user may be beneficial to ensure that duplicate entries per user are not counted as part of the measure of uniqueness of the API transactions. In other words, the comparison for uniqueness/commonality may be performed between communications of many users rather than between communications of the same user.

In step 406, API security system 604 scans the fields of each transaction to determine a uniqueness of the information in each field. In other words, API security system 604 scans the fields to determine fields that have repeating values amongst many different users and determine fields which do not have repeating values or only repeat among a small number of users. In one example, the scanning processing may be implemented by extracting the data values of each field and building a log history of values for each field. For example, if account numbers are in the field being scanned, the log history may be generated where each user using the account number is placed in the same bin. For example, a group of users using a common account number (perhaps shared between family members or a small group of users sharing the same account) may be placed into the same bin. The numbers of distinct users per bin give an indication of how unique/common data is for a particular field. For example, a user account number history log may show a high level of uniqueness in that any given account number may be used by 1 user or up to a limited number of users (e.g., 4 family members). In contrast, the address domain log history, for example, may show a low level of uniqueness in that all users use the same address domain and therefore the same address domain will always be present in the GET command.

In any event, once each transaction is scanned, the system determines the level of uniqueness/commonality per field over multiple users and labels the fields as either being a sensitive field or a non-sensitive field, and also determines the level of uniqueness/commonality per multiple transactions of the same user to determine if the field is a false positive that should be ignored. For example, if API security system 604 determines in step 408 that the field value is common to more than N users (a yes at step 408), the system labels the field as being a non-sensitive field in step 414. The non-sensitive field may then be removed from further analysis. In other words, the non-sensitive fields may be deleted or ignored for further processing because non-sensitive fields offer little to no value to bad actors, and therefore do not require security intervention. If API security system 604 determines in step 408 that the field value is not common to more than N users (a no at step 408), the system suspects the field as being sensitive and moves on to step 410 to determine if the field values of a given field are less than or equal to a predetermined number of M distinct values (e.g., M=1) per user. If the field values include less than or equal to M distinct values (a YES at step 410), the system determines that the field is sensitive in step 412. If the field values include greater than M distinct values (a NO at step 410), the system may label the field as being a non-sensitive false positive field in step 416. The false positive field may then be removed from further analysis. This step is beneficial for distinguishing fields having unique values due to normal system operation as apposed to fields having unique values due personal information that can be utilized by a bad actor. For example, values that are unique per user due to normal system operation (e.g., each transaction may generate a unique timestamp or some other randomly generated field that is unique to API communication transactions for the same user) cannot be utilized by a bad actor and therefore may be removed from further processing, whereas values that are unique per user due to user personal information (e.g., social security number (SSN) value is unique per user but is common over all the transactions of the same user) can be utilized by a bad actor and therefore should be indicated as sensitive. In other words, steps 408, 410, 414 and 416 attempt to identify sensitive fields as being fields that are common to a small group of users, while avoiding fields that produce unique values due to normal system operation. This eliminates both non-sensitive fields (e.g., fields with values common to a large number of users) and false positive fields (e.g., fields with values unique on a per user basis due to system operation) from the analysis.

Once the sensitive fields and values are identified, the sensitive fields are maintained for further analysis in step 412. These fields are essentially broken fields because they are a point of weakness that can be exploited by a bad actor. The further analysis performed by the system may include a determination of how to fix the broken field and actions for fixing the broken field.

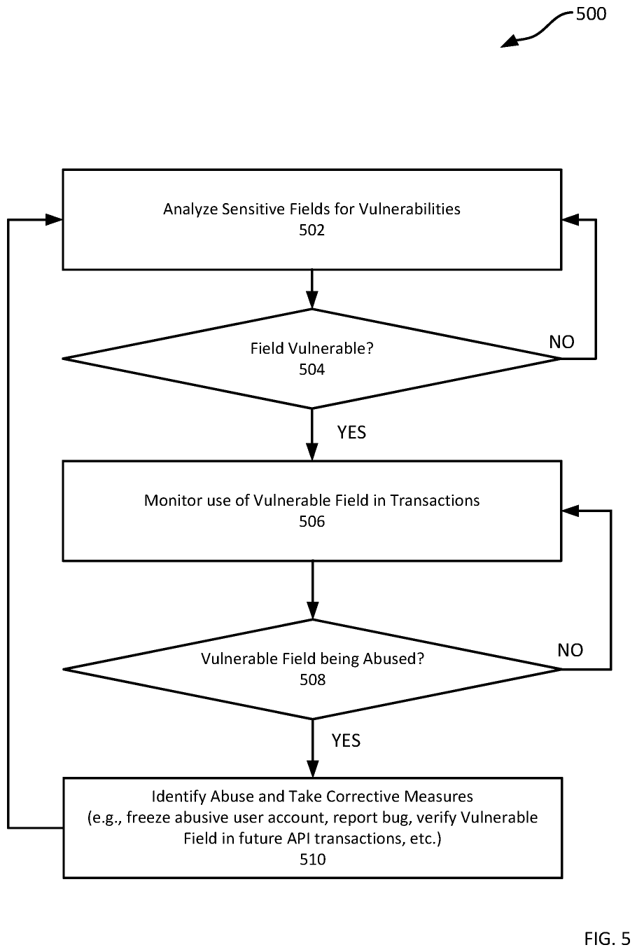

Examples of the system determining how to fix the broken authorization field and actions for fixing the broken authorization field may include modifying the values in the broken fields or requiring additional authorization (i.e., validation) when using broken fields in API communications. FIG. 5, for example, shows a flowchart of a process 500 for the implementation phase of the API security system. In step 502, API security system 604 analyzes the sensitive fields for vulnerabilities. For example, in the case of the user account field, the API security system 604 may determine predictable patterns present in the scanned user account field values. If a pattern is detected, the pattern may present a vulnerability (i.e., the bad actor can predict other user account numbers based on the pattern). In step 504, API security system 604 determines if the field is vulnerable or not. If the field does not have a vulnerability such as a predictable pattern (a no at step 504), the system repeats step 502 and analyzes the next sensitive field in the list. In other words, just because a field is sensitive does not mean it is vulnerable to attacks as long as the field values cannot be used by a bad actor to predict other field values for other users.

However, if the field does have a vulnerability (a yes at step 504) such as incrementing account number values that can be used to predict other account numbers, then further action is taken in steps 506, 508 and 510. Specifically, API security system 604 determines an appropriate solution for addressing the vulnerability. The solution may include, but is not limited to, identifying abuse of a field and taking corrective measures to mitigate the abuse. The corrective measures may include freezing abusive user accounts, reporting the abuse as a bug in the system, and fixing the bug by modifying future API transactions and verifying values in vulnerable fields in future API transactions (e.g., actions for correcting the authorization issue relating to the vulnerable field(s)). Of course, other solutions are possible such as one or more of masking/encryption of vulnerable field values, or re-authentication steps executed when API transactions utilize the vulnerable field data. In other words, the vulnerable field can be addressed by fixing the values themselves or by protecting the vulnerable values through security mechanisms. It is noted that the corrective measures may be performed by the API security system 604, the host system 606 where the API transactions are being performed, or a combination of both systems. In one example, API security system 604 may take corrective measures by identifying the abuse of a field and actively making corrections (e.g., fixing bugs, verifying vulnerable fields, etc.) to subsequent API transactions. In another example, API security system 604 may take corrective measures by identifying the abuse of a field and reporting the abuse to another security system which may be executing on host system 606 or on another device (not shown). This other security system may take one or more actions such as making corrections (e.g., fixing bugs, verifying vulnerable fields) for securing subsequent API transactions, blocking the user by closing the session or redirecting the user to a honeypot, or monitoring activity more closely to name few. Furthermore, the chosen solution may be dependent on various factors including, but not limited to, capabilities of the host device, importance of the field, and user experience to name a few.

For example, if a vulnerable field monitored in step 506 is determined to be abused over one or more API transactions in step 508, the system identifies the abuse and takes corrective measures. This ensures that vulnerable fields in further API transactions are no longer abused. For example, the corrective measures may include freezing the abusive account and requiring verification of vulnerable fields in future API requests. In other words, the abusive user is stopped from abusing the system, and any future abuse is prevented by the system performing a back-end verification of the vulnerable API fields (e.g., verifying that the SSN entered in the API transaction is associated with the SSN of the user account). Therefore, the solution may be seamless from the perspective of the end user.

As mentioned above, an example of a vulnerable field may be an account number field with account numbers that are mere increments of one another. A first solution for addressing this vulnerability may be actions for correcting the authorization issue relating to the vulnerable field(s) (e.g., modifying future API transactions to perform verification of values in vulnerable fields in future API transactions). A second solution may be freezing bad actor accounts and performing back-end verifications of the vulnerable field in future API transactions to ensure that vulnerable field values are associated with the account of the requesting user. A third solution may be implemented by asking the user to perform re-authentication each time the user account number is used in an API request. This may stop bad actors because bad actors are not able to perform re-authentication. In fourth solution, the account number may be encrypted with a secret key known to the user device and the host device. This may prevent a bad actor from being able to determine the user account number in an intercepted API communication. In yet a fifth solution, the account number format may be changed such that the account numbers do not exhibit a pattern. In other words, a new account number format may be chosen to reduce correlation between account numbers.

Regardless of the technique chosen, once the solution is determined, API security system 604 implements the solution by modifies the procedure of the API transaction which may include modifying the API code. For example, API security system 604 may change parameters or alter the programing code in the API protocol to support the solution (e.g., verifying vulnerable fields, encryption of data, modification of data, re-authentication, etc.). The steps shown in FIG. 5 may be repeated for each field until the vulnerable fields have been identified and abused vulnerable fields are protected from further abuse.

It is noted that although the API solution described above is applied to BOLA attacks, the solution is not limited to protecting against BOLA attacks. For example, the above-described solution can also identify other behaviors such as, but not limited to abusive access attempts such as assets scanning attacks. For example, in the context of assets scanning attacks, a bad actor may launch a cyber-attack with the goal of gaining visibility into a target system. This may include attempting to determine hardware in the target system and services running on the hardware, identify vulnerabilities and gather metadata to name a few. Some assets scanning techniques may include pinging hardware, port scanning and other vulnerability type scanning methods to determine potential targets and entry points into the target system. Since these scanning attacks also utilize the API of the target system, the API solution described above may monitor and analyze the access scanning behavior in a similar manner as shown in FIGS. 4 and 5. A goal would be to identify sensitive access API features, determine vulnerabilities and take corrective measures if needed.

FIG. 6 shows an example of a system 600 configured for providing the API security mechanism disclosed herein. It should be understood that the components of the system 600 shown in FIG. 6 and described herein are merely examples and systems with additional, alternative, or fewer number of components should be considered within the scope of this disclosure.

As shown, system 600 comprises at least one end user device 602 and servers 604 and 606 interconnected through a network 610. In the illustrated example, server 604 supports operation of the API security mechanism and server 606 supports operation of the host system. In the illustrated example, user device 602 is a PC, but may be any device (e.g., smartphone, tablet, server, etc.) providing access to the servers via network 610. User device 602 may have a user interface UI, which may communicate with the servers using the network 610 via a browser or via software applications. For example, user device 602 may allow the user to access information (e.g., objects) stored on server 606 via API requests and responses. API security device 604 may support the learning phase and implementation phase of the API security system disclosed herein. The network 610 may be the Internet and or other public or private networks or combinations thereof. The network 610 therefore should be understood to include any type of circuit switching network, packet switching network, or a combination thereof. Non-limiting examples of the network 610 may include a local area network (LAN), metropolitan area network (MAN), wide area network (WAN), and the like.

In an example, end user device 602 may communicate with servers 604 and 606 via a software application to control the API security system disclosed herein. The software application may initiate server 604 to perform the learning and implementation phases of the API security mechanism according to the systems/methods shown in FIGS. 4-5.

Servers 604, 606 and user device 602 are each depicted as single devices for ease of illustration, but those of ordinary skill in the art will appreciate that servers 604 and 606 and user device 602 may be embodied in different forms for different implementations. For example, any or each of the servers may include a plurality of servers including a plurality of databases, etc. Alternatively, the operations performed by any of the servers may be performed on fewer (e.g., one or two) servers. For example, although security system 604 and host system 606 are shown as different devices, they could be integrated into the same device. In another example, a plurality of user devices (not shown) may communicate with the servers. Furthermore, a single user may have multiple user devices (not shown), and/or there may be multiple users (not shown) each having their own respective user devices (not shown). Regardless, the hardware configuration shown in FIG. 6 may be a system that supports the functionality of the API security system disclosed herein.

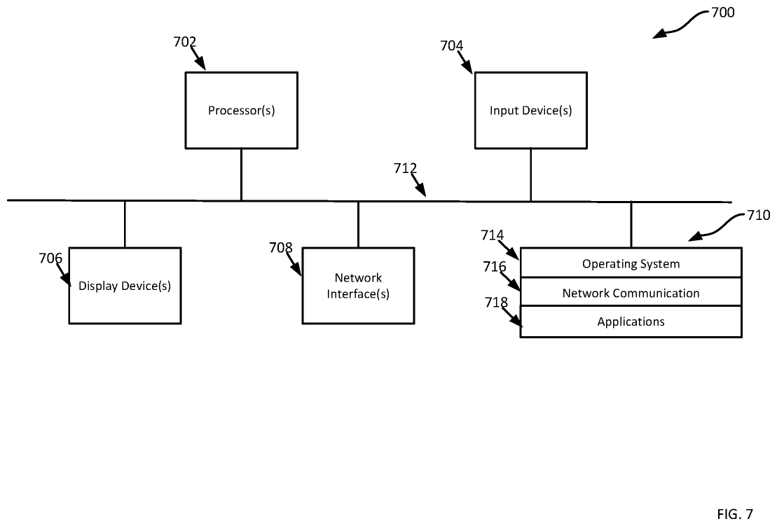

FIG. 7 shows a block diagram of an example computing device 700 that is configured for facilitating the API security system based on the principles disclosed herein. Computing device 700 may be either a physical or a virtual computing device. For example, computing device 700 may function as the servers 604, 606 and/or user device 602, or a portion or combination thereof in some embodiments. The computing device 700 performs one or more steps of the methods shown in FIGS. 4-5. The computing device 700 is implemented on any electronic device that runs software applications derived from compiled instructions, including without limitation personal computers, servers, smart phones, media players, electronic tablets, game consoles, email devices, etc. In some implementations, the computing device 700 includes one or more processors 702, one or more input devices 704, one or more display devices 706, one or more network interfaces 708, and one or more computer-readable media 710. Each of these components is coupled by a bus 712.

Display device 706 includes any display technology, including but not limited to display devices using Liquid Crystal Display (LCD) or Light Emitting Diode (LED) technology. Processor(s) 702 uses any processor technology, including but not limited to graphics processors and multi-core processors. Input device 704 includes any known input device technology, including but not limited to a keyboard (including a virtual keyboard), mouse, track ball, and touch-sensitive pad or display. Bus 712 includes any internal or external bus technology, including but not limited to ISA, EISA, PCI, PCI Express, USB, Serial ATA or FireWire. Computer-readable medium 710 includes any non-transitory computer readable medium that provides instructions to processor(s) 702 for execution, including without limitation, non-volatile storage media (e.g., optical disks, magnetic disks, flash drives, etc.), or volatile media (e.g., SDRAM, ROM, etc.).

Computer-readable medium 710 includes various instructions 714 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 704; sending output to display device 706; keeping track of files and directories on computer-readable medium 710; controlling peripheral devices (e.g., disk drives, printers, etc.) which can be controlled directly or through an I/O controller; and managing traffic on bus 712. Network communications instructions 716 establish and maintain network connections (e.g., software for implementing communication protocols, such as TCP/IP, HTTP, Ethernet, telephony, etc.). Application(s) 718 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

The described features may also be implemented in one or more specialized hardware devices such as a field programmable gate array (FPGA), or an application specific integrated circuit (ASIC). These hardware-based solutions may be coded using hardware description languages (HDLs) such as Verilog and VHDL.

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a user computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include user devices and servers. A user device and server may generally be remote from each other and may typically interact through a network. The relationship of user device and server may arise by virtue of computer programs running on the respective computers and having a relationship with each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API described herein may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method performed by a processor, the method comprising:
collecting a subset of application programming interface (API) transactions between a plurality of users and a host system;
analyzing fields in the subset of API transactions, the analyzing including identifying the fields as sensitive fields when information in the fields is common to less than or equal to a first predetermined number of the plurality of users; and
performing corrective measures to protect the usage of the sensitive fields.

2. The method of claim 1, further comprising:
identifying the fields as non-sensitive fields when information in the fields is common to more than the first predetermined number of the plurality of users; and
ignoring the non-sensitive fields in subsequent API transactions.

3. The method of claim 1, further comprising:
identifying the fields as false positive fields when information in the fields is distinct to over a predetermined number of API transactions for a user of the plurality of users; and
ignoring the false positive fields in subsequent API transactions.

4. The method of claim 1, further comprising:
analyzing the fields in the subset of API transactions by grouping the API transactions per user and comparing the grouped API transactions across the plurality of users.

5. The method of claim 1, further comprising:
analyzing the API transactions including API requests from the plurality of users to the host system for information and API responses from the host system to the plurality of users with the requested information.

6. The method of claim 1, wherein the sensitive fields include at least one of private account information of the plurality of users or private personal information of the plurality of users.

7. The method of claim 1, wherein the first predetermined number is set to 1 or to a value representing a number of users that share a common account on the host system.

8. The method of claim 1, further comprising:
collecting the subset of API transactions and analyzing the fields in the subset of API transactions either periodically or upon request by the host system.

9. The method of claim 1, further comprising:
prior to the performing of the corrective measures, determining if the sensitive fields are being abused, and performing the corrective measures to protect the usage of the sensitive fields that are determined to be abused.

10. The method of claim 1, further comprising:
performing the corrective measures to protect the information in the sensitive fields by verifying that the information in the sensitive fields is associated with a user account involved in subsequent API transactions.

11. A system comprising:
a non-transitory storage medium storing computer program instructions; and
one or more processors configured to execute the computer program instructions to cause operations comprising:
collecting a subset of application programming interface (API) transactions between a plurality of users and a host system;
analyzing fields in the subset of API transactions, the analyzing including identifying the fields as sensitive fields when information in the fields is common to less than or equal to a first predetermined number of the plurality of users; and
performing corrective measures to protect usage of the sensitive fields.

12. The system of claim 11, wherein the operations further comprise:
identifying the fields as non-sensitive fields when information in the fields is common to more than the first predetermined number of the plurality of users; and
ignoring the non-sensitive fields in subsequent API transactions.

13. The system of claim 11, wherein the operations further comprise:
identifying the fields as false positive fields when information in the fields is distinct to over a predetermined number of API transactions for a user of the plurality of users; and
ignoring the false positive fields in subsequent API transactions.

14. The system of claim 11, wherein the operations further comprise:
analyzing the fields in the subset of API transactions by grouping the API transactions per user and comparing the grouped API transactions across the plurality of users.

15. The system of claim 11, wherein the operations further comprise:
analyzing the API transactions including API requests from the plurality of users to the host system for information and API responses from the host system to the plurality of users with the requested information.

16. The system of claim 11, wherein the sensitive fields include at least one of private account information of the plurality of users or private personal information of the plurality of users.

17. The system of claim 11, wherein the first predetermined number is set to 1 or to a value representing a number of users that share a common account on the host system.

18. The system of claim 11, wherein the operations further comprise:
collecting the subset of API transactions and analyzing the fields in the subset of API transactions either periodically or upon request by the host system.

19. The system of claim 11, wherein the operations further comprise:
prior to the performing of the corrective measures, determining if the sensitive fields are being abused, and performing the corrective measures to protect the usage of the sensitive fields that are determined to be abused.

20. The system of claim 11, wherein the operations further comprise:
performing the corrective measures to protect the information in the sensitive fields verifying that the information in the sensitive fields is associated with a user account involved in subsequent API transactions.
